(19) United States
(12) Patent Application Publication
(10) Pub. No.: US 2015/0331960 A1
(43) Pub. Date: Nov. 19, 2015

(54) SYSTEM AND METHOD OF CREATING AN IMMERSIVE EXPERIENCE

(71) Applicant: Nickel Media Inc., Halifax (CA)

(72) Inventor: Jason NICKEL, Halifax (CA)

(21) Appl. No.: 14/713,745

(22) Filed: May 15, 2015

Related U.S. Application Data
(60) Provisional application No. 61/993,448, filed on May 15, 2014.

(51) Int. Cl. G06F 17/30; G06F 3/0484

(52) U.S. Cl. CPC G06F 17/30905; G06F 17/30896; G06F 3/04842

(57) ABSTRACT

A method of creating immersive content comprised of both traditional content and user-generated content for consumption by a consumer includes creating a flow list that defines an order of immersive content. The method further includes attaching a node to the flow list that defines user-generated content to be included in the flow list, and identifying for the attached node a type of user-generated content to be provided, a source of the user-generated content to be provided, and selection criteria for the user-generated content selected for inclusion in the content node. The method further includes compiling immersive content for consumption by the consumer based on the plurality of content nodes and content made available by the consumer for inclusion per one or more of the content nodes.

### CROSS-REFERENCE TO RELATED APPLICATION

This application claims benefit of U.S. Provisional Application No. 61/993,448, filed on 15 May 2014 and which application is incorporated herein by reference. A claim of priority is made.

### TECHNICAL FIELD

This disclosure relates to media content and delivery and in particular to immersive media content.

### BACKGROUND

With advancement in technology has come a deluge of media content options for consumers. In particular, the Internet has made it possible for users to stream music and movies at any time, and share things about themselves via websites like Youtube and Facebook. However, despite the various ways a user may access content, in most instances the user consumes the content in the same way the user has always consumed the content: passively.

### SUMMARY

An exemplary embodiment of a method of creating immersive content comprised of both traditional content and user-generated content for consumption by a user includes creating a flow list that defines an order of immersive content. The method further includes attaching a node to the flow list that defines user-generated content to be included in the flow list, and identifying for the attached node a type of user-generated content to be provided, a source of the user-generated content to be provided, and selection criteria for the user-generated content selected for inclusion in the content node. The method further includes compiling immersive content for consumption by the user based on the plurality of content nodes and content made available by the user for inclusion per one or more of the content nodes.

### BRIEF DESCRIPTION OF THE DRAWINGS

FIG. 1 is a block diagram of a system of developing and distributing immersive content to a user according to an embodiment of the present invention.

FIG. 2 is a block diagram that illustrates functional components of an immersive content system according to an embodiment of the present invention.

FIG. 3 is a flowchart that illustrates development of immersive content by a developer according to an embodiment of the present invention.

FIG. 4 is a block diagram of an exemplary flow list created by a developer that describes the intersection of traditional content and user-generated content according to an embodiment of the present invention.

FIG. 5 is a flowchart illustrating operations performed by application logic associated with a node in an exemplary flow list according to an embodiment of the present invention.

FIG. 6 is a development software screenshot illustrating creation of a content node for inclusion into a flow list according to an embodiment of the present invention.

FIG. 7 is a flowchart illustrating delivery of immersive content according to an exemplary embodiment of the present invention.

FIG. 8 is a flowchart illustrating delivery of immersive content that includes specialized content directed to a user's mobile device according to an exemplary embodiment of the present invention.

FIG. 9 is a flowchart illustrating delivery of immersive content as part of a digital advertisement according to an embodiment of the present invention.

### DETAILED DESCRIPTION

The present invention provides a system and method of providing immersive content to a consumer, such that the consumer or content associated with the consumer is utilized to generate unique content delivered to the consumer that provides an immersive, active role for the consumer in the content consumed.

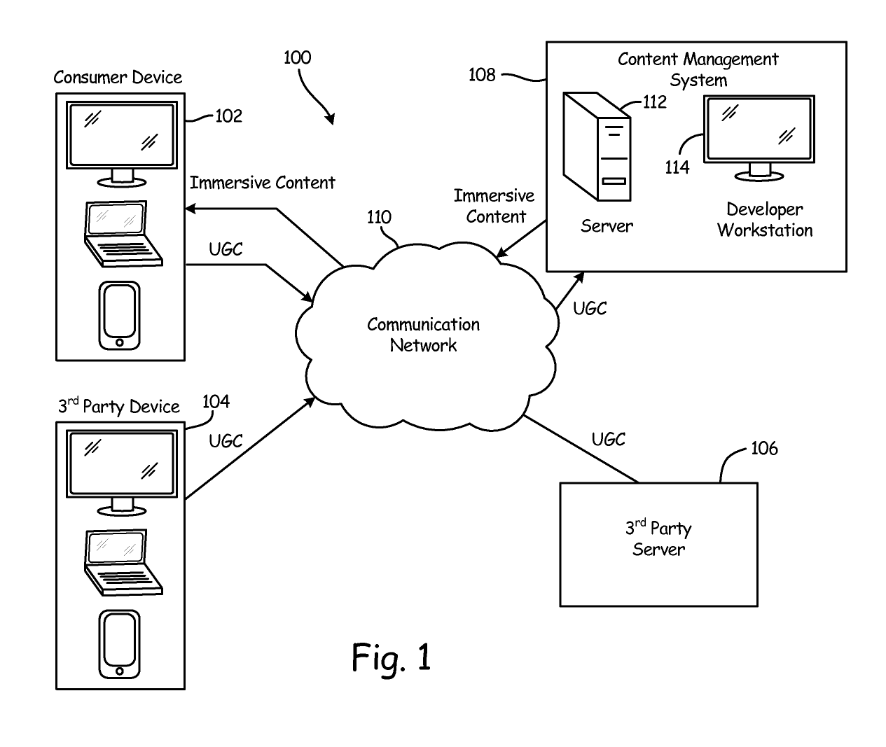

FIG. 1 is a block diagram of system 100, used to develop and distribute immersive content to a consumer according to an embodiment of the present invention. System 100 includes consumer device 102, 3^{rd} party device 104, third-party content provider 106, content management system (CMS) 108 and communication network 110.

CMS 108 includes computer server 112 and developer workstation 114. A developer utilizes developer workstation 114 to create the framework for the immersive content to be delivered to the consumer. Unlike traditional media content, in which content is shot, edited, and compiled for linear consumption by all consumers, in the same way, the immersive content provided to each consumer is unique based on the user-generated content (UGC) provided by the consumer or with respect to the consumer. The framework created by the developer includes a flow list that defines how UGC is fit within the context of the story or content to be delivered to the consumer. Because the developer does not know what content will be made available by or provided by the user, the flow list includes decisions about how to respond to the presence or absence of UGC, as well as how provided UGC can be incorporated without requiring interaction from the developer with respect to each consumer.

The developed framework is deployed or published to computer server 112. Once deployed or published, consumer devices can access the published framework and request immersive content. For example, consumer device 102—which may be any device capable of communicating via communication network 110, such as a desktop computer, a laptop, a tablet, or a mobile phone—provides user-generated content (UGC) to CMS 108 via communication network 110. In addition, UGC may be provided by other users to CMS 108 via their respective devices 104 and/or by third-party server 106 via communication network 110. For example, a secondary user (e.g., friend of the consumer), may provide UGC to CMS 108 for inclusion in immersive content to be provided to consumer device 102. In addition, a consumer may provide CMS 108 with access to UGC content stored on third-party server 106 (e.g., Facebook, Instagram, etc.). In response to UGC collected from one or more of these sources, CMS 108 compiles immersive content for provision to consumer device 102 via communication network 110.

User-generated content (UGC) refers broadly to a range of media formats and types. For example, UGC may include pictures/images, videos, blog posts, music playlists, social media content, emails, text messages, and other media formats. In addition, UGC may be provided directly by the consumer, may be provided by a 3^{rd} party, or may be collected automatically by CMS 108 following consent by the consumer. For example, the consumer may provide consent to CMS 108 to access the consumer's social media account and collect UGC from the account, or a second user (e.g., friend of the consumer) may supply UGC to CMS 108.

Based on the received UGC, CMS 108 generates immersive content for provision to the consumer. Similar to UGC, immersive content refers broadly to a range of media formats and types. For example, immersive content may include pictures/images, videos, blog posts, audio, social media updates, emails, text messages, computer-initiated telephone calls, and other media formats. Immersive content utilizes and/or incorporates collected UGC such that immersive content returned to the consumer for consumption is unique to that particular consumer. In one embodiment, immersive content may include a combination of traditional content and UGC, interwoven together to create a story that includes the consumer. In other embodiments, analysis UGC allows immersive content to be tailored to the individual consumer, based on information gleaned from analysis of UGC provided or received with respect to the consumer.

That is, immersive contents may include inclusion of UGC into the returned content, and/or may include utilizing information obtained about the user from the UGC to determine the immersive content provided. An example of the former may include the interweaving pre-shot video footage with UGC video footage. For example, a horror story may include pre-shot video footage of the villain walking down the street, interwoven with video of the consumer's house, to make it appear that the villain is approaching the consumer's front door. In the latter case, UGC is utilized only to learn about the consumer in order to generate immersive content that will resonate with the user. For example, UGC can be utilized to determine the consumer's best friend, and then immersive content provided to the consumer may make use of this fact, without actually including in the immersive content and UGC. In addition, immersive content may provide a combination of including UGC into the immersive content provided, and analyzing UGC provided to determine and select immersive content provided to the consumer. In addition, immersive content may be provided in a single media format (e.g., video), or may include several different types of media format, interrupted by points in time which required additional consumer feedback or interaction.

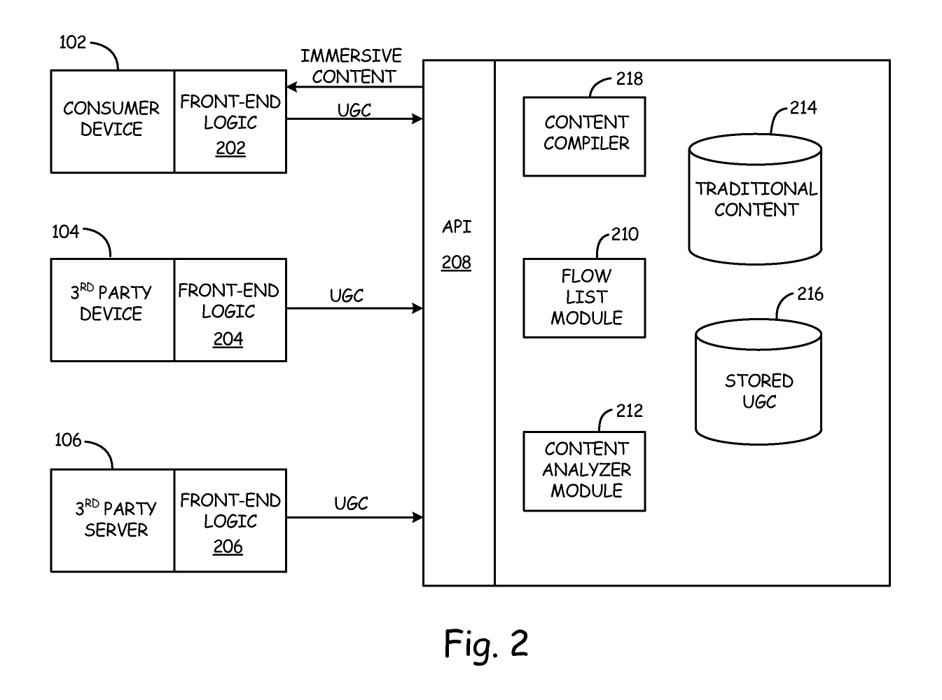

FIG. 2 is a block diagram illustrating functional components implemented by the system shown in FIG. 1 according to an embodiment of the present invention. The system once again includes consumer device 102, 3^{rd} party device 104, third-party server 106, and content management system 108. Hardware associated with each of these components has been removed to illustrate the functional actions included in and implemented by each component. For example, with respect to consumer device 102, the various types of devices that a consumer may use to access content management system 108 have been removed and only functional front-end logic 202 implemented by software running on one of the consumer devices is shown. Similarly, 3^{rd} party device 104 includes front-end logic 204 and third-party server 106 includes front-end logic 206.

Front-end logic 202, 204, 206 may be stored on each of these devices in the form a software program or “App” running on the device. Front-end logic provides an interface for interacting with CMS 108. Depending on the application, front-end logic may also provide processing/analytics of UGC in a “client-side” approach to UGC processing. In a “client-side” approach, CMS 108 provides the tools for analyzing UGC and/or for selecting UGC for inclusion in the immersive content. A benefit of this approach is that it does not require a consumer or user to communicate (via upload) all UGC made available to content management system 108. Rather, front-end logic determines, based on input received from content management system 108, what UGC or UGC analytics to provide to CMS 108. In addition, front-end logic 202 is responsible for delivering immersive content to the consumer's device for consumption.

Hardware associated with CMS 108—including server 112 and developer workstation 114—have likewise been removed from this embodiment. Functional components implemented by the combination of server 112 and developer workstation 114 include application programming interface (API) 208, flow list module 210, content analyzer module 212, UGC database 216, traditional content database 214, and content compiler 218. UGC received from a consumer or other participant is stored in UGC database 216, while traditional content not obtained by a consumer and/or other participant is stored in traditional content database 214, although in other embodiments both traditional content and UGC content may be combined into the same data store.

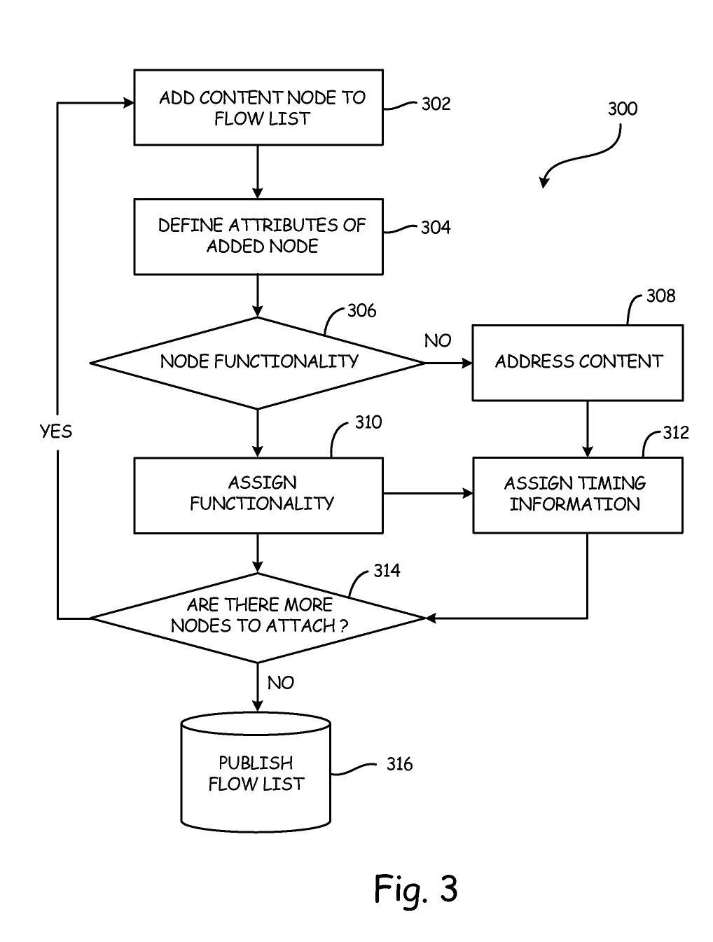

API 208 provides the interface between external devices (e.g., consumer device 102, second device 104, and third-party server 106) and content management system 108. Flow list module 210 is the framework created by the developer—via developer workstation 114 (shown in FIG. 1)—that describes the story to be presented to the consumer. As described in more detail with respect to FIG. 3, the flow list maintained by flow list module 210 is comprised of a plurality of nodes that together provide the framework for the immersive content provided to the consumer. For example, the developer may create a node that describes traditional video content to be supplied to the consumer. An additional node may describe the inclusion of UGC content either embedded as part of the traditional video content or to follow it. In addition, the flow list maintained by flow list module 210 may include many multiple paths or branches from node to node. A decision to travel down one a plurality of possible paths or branches may be based on a number of things, including interaction/decisions made by the consumer and/or analysis of UGC provided by the user.

Content analyzer module 212 is responsible for analyzing UGC. This may include selecting UGC from a plurality of possibilities for inclusion in immersive content and/or analyzing UGC to retrieve analytics regarding the content that can be used to determine the immersive content delivered to the user. In one embodiment, content analyzer module 212 utilizes artificial intelligence to analyze UGC received from a consumer in real-time and provide responses based on that analysis. For example, this could be used to incorporate back and forth responses with the consumer as part of the immersive experience, providing the consumer with the illusion that they are interacting with an actual person.

As described above, in some embodiments it may be beneficial to communicate operations performed by content analyzer module 212 to individual devices for execution locally by front-end logic 202, 204 and/or 206. As described above, a benefit of this approach is that it only requires transferring the code segments to the consumer device, and does not require the consumer and/or user to transfer/upload extensive media content to content management system 108 for analysis. For example, in one embodiment, a node in the flow list identifies a certain type of UGC to be included in the immersive content (e.g., a wedding picture). In some cases, the consumer or other party is prompted for the desired UGC, which is then provided directly to CMS 108. However, in other embodiments it may be necessary to automatically locate the desired content without input from the consumer or other parties. In this type of embodiments, content analyzer module 212 utilizes an algorithm or set of criteria defined by the developer to select desired UGC from all available UGC. For example, to locate an image of a wedding, content analyzer module 212 may include an image analyzer program configured to analyze UGC images and detect those matching certain criteria (e.g., white dress and tuxedos), or may analyze tags associated with UGC images, looking for keywords such as “bride” or “wedding”. As described above, analysis may be performed by content analyzer module 212 at CMS 108 or locally at the device providing the UGC. Once selected, UGC is stored to user-generated content database 216.

Having collected and stored desired UGC, content compiler 218 is utilized to compile immersive content to be delivered to the consumer. This may include combining/interleaving UGC with traditional content so that it appears to the user that the UGC is a part of the delivered immersive content. For example, in an embodiment in which UGC images and/or video are to be embedded as part of traditional content video, content compiler 218 is responsible for compositing the UGC images/video into the static or traditional content video such that a seamless video file is provided for playback to the consumer via consumer device 102. Compositing UGC into traditional content (or vice versa) is one example of operations performed by content compiler 218 to provide immersive content to the user. In other embodiments, it may include constructing traditional content based on UGC analytics provided by content analyzer module 212. For example, based on provided UGC, content compiler 218 may create text messages/instant messages delivered to the consumer. Although this type of immersive content does not include any UGC provided by the consumer or user, it is based on analysis of retrieved UGC.

A benefit of the present invention is that immersive content is compiled by CMS 108 in a server-side operation. This is particularly beneficial when delivering content to mobile devices which typically do not include Flash capability nor the processing power for complex processing/compiling operations. In this way, content is collected, analyzed, and compiled on the server-side and then delivered to the consumer for consumption only in a format that can be played or viewed on the consumer's device.

In addition, the interaction between consumer device 102 and CMS 108 may include a plurality of individual interactions. Thus, immersive content delivered to a user may require content compiler 218 to compile content at a number of different stages of the immersive content interaction with consumer device 102.

FIG. 3 is a flowchart that illustrates method 300 of developing immersive content according to an embodiment of the present invention. In particular, method 300 describes the process by which a developer—utilizing developer workstation 114 (shown in FIG. 1)—creates the plurality of nodes that makes up the flow list utilized by flow list module 210 (shown in FIG. 2) to deliver immersive content to the consumer.

At step 302, the developer adds a content node to the flow list. The node may be added through a graphical user interface (GUI) that allows the developer to see the interaction and placement of the node relative to other nodes.

At step 304, the user defines attributes of the node. For example, this may include defining the type of content to be displayed by the node (e.g., video content, image content, etc.), as well as the type of interaction to be provided by the node (e.g., dynamic/static video, interactive component, etc.).

At step 306, a determination is made whether the node requires added functionality. If no added functionality is required (e.g., static, traditional content is being provided by the node), then at step 308 the developer simply links to or otherwise addresses the content to be referenced by the node. For example, for content stored by traditional content database 214, this would include creating the URL pointing to the stored content.

If the node requires functionality, then at step 310 the developer attaches or otherwise assigns functionality to the node. For example, this may include associating application logic such as PHP scripts, Javascript, or .NET scripts with the created node. Functionality associated with selection of UGC and/or analysis of provided UGC is based on application logic associated with each of the plurality of nodes. For example, the application logic may be designed to select a particular image or type of content to be included in immersive content returned to the consumer. In the example provided above, if the immersive content requires an image of the consumer at a wedding, the application logic may provide image analysis of provided UGC to select an image that includes a white dress. Alternatively, the application logic may provide analysis of texts or tags associated with UGC that matches the term “wedding” or “bride”. Although the particular programming associated with these solutions will be very different, the net result of both of these application logic programs is to identify images of the consumer at a wedding. In other embodiments, functionality attached to a node may include artificial intelligence utilized to interact with the consumer. As described above, this allows for the framework incorporated by the developer to include interaction via text messages/social media sites that appears to the consumer as if they are interacting with a real person. Application logic may be stored and executed directly from the created node, or may be stored separately; the location of the application logic referenced by the individual node.

At step 312, timing information is associated with the node, if necessary. For example, for UGC embedded within traditional content, this may include cut-in/cut-out times associated with the traditional content, or other indications of when the content should be provided to the consumer, either in isolation or in combination with other content being provided. In other embodiments, timing information includes additional trigger points that dictate progression to the next node. For example, if this node requires interaction from the consumer, the trigger may be based on receiving a valid input from the consumer. In other embodiments, timing information may include, depending on factors such as the type of media content associated with the node, additional instructions regarding timing of provision of the content to the consumer, either in isolation or in relation to other content.

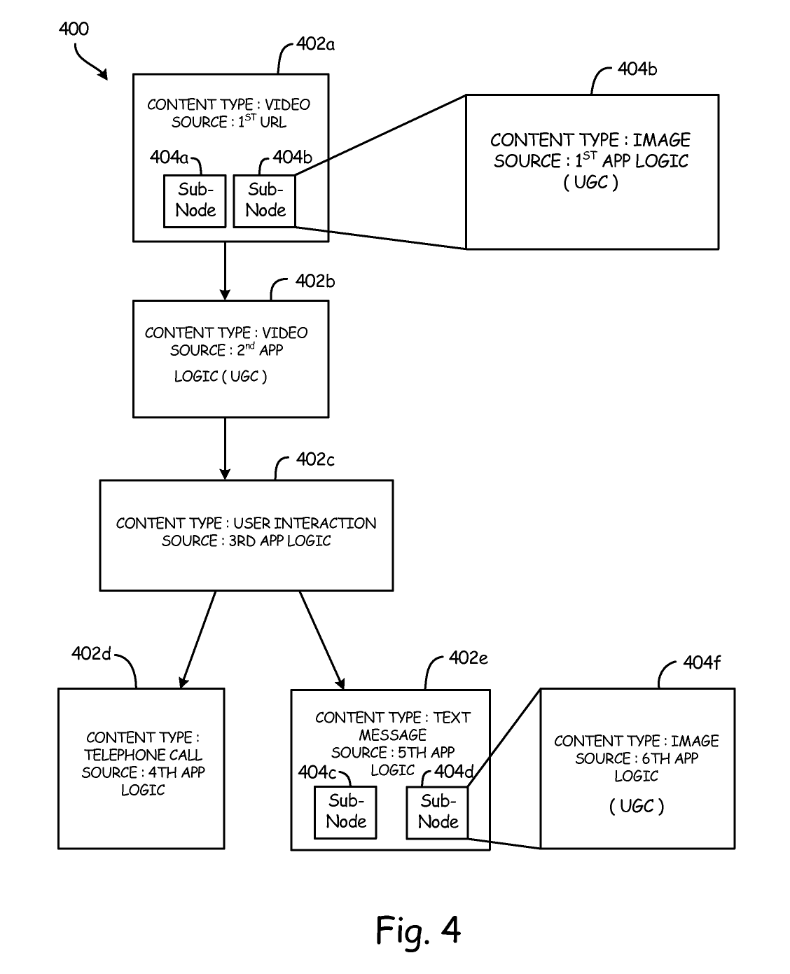

FIG. 4 is a block diagram of a graphical user interface (GUI) utilized by a developer to create an exemplary flow list 400, which describes the intersection/interaction between traditional content and user-generated content according to an embodiment of the present invention. The exemplary GUI provided in FIG. 4 is an illustration of one tool that may be utilized to create flow list 400. In other embodiments, flow list 400 is created using well-known programming languages without the presence of a GUI. However, the GUI provides a framework that allows the developer to physically visualize the flow of content to be delivered to the user.

Exemplary flow list 400 includes a plurality of nodes labeled 402a-402e, as well as a plurality of sub-nodes 404a-404f. The order of the plurality of nodes 402a-402g and sub-node 404a-404f, and information contained therein, defines the immersive content to be provided for consumption to the consumer. Because UGC is not available to the developer at the time of development, the nodes provide a framework for dynamically collecting and compiling UGC, along with traditional content, into immersive content that can be provided for consumption.

The exemplary flow list 400 illustrated in FIG. 4 is an example of one such flow list. Each of the plurality of nodes 402a-402e includes a plurality of fields used by the developer to identify the type of content associated with the node, the source of the content, timing information associated with the content, and information regarding the next content (e.g., node) to be utilized. For example, node 402(a) is the first node created by the developer. In this example, node 402(a) provides traditional, static video content to the consumer. The developer identifies in the content type field that the content to be provided is “video content”. In one embodiment, a drop-down menu may be provided to the developer to allow the developer to choose from a plurality of content type options (e.g., video, image, audio, text message, video call, etc.). In addition, the developer identifies the location of the video content associated with the node. In this case, because the content is not UGC, the address or URL identifying the location of the content (e.g., traditional content database 214 shown in FIG. 2) is provided by the developer. The developer also provides timing information, if required, regarding when the content should be provided to the consumer. In the embodiment shown in FIG. 4, no timing information is provided.

In addition, node 402a includes one or more sub-nodes 404a and 404b. Sub-nodes—in principle—have the same structure as nodes, but are embedded or nested within a node such that content provided by the sub-nodes is delivered within the context or framework of the parent node. Content provided by sub-nodes (e.g., sub-nodes 404a, 404b) may include traditional, static content or UGC.

In the embodiment shown in FIG. 4, while creating node 402a, the developer also creates sub-nodes 404a and 404b. With respect to sub-node 404b, the developer provides that the content type associated with the sub-node is an image, and that the source of the image is application logic (denoted here as first application logic). As described above, application logic may include PHP scripts, Javascript, or .NET scripts that allow the developer to interact with other systems to dynamically collect/analyze user-generated content (UGC). Because the image is being provided by the user/consumer, the developer cannot identify the source (i.e., location) of the image within any database. Rather, the developer provides as the source the application logic or address to application logic to be used to select the desired image from the user/consumer. For example, as discussed above, this may include image analysis programming utilized to select a particular type of image, textual analysis of tags, descriptions associated with the image, and/or frequency of views associated with an image. In another embodiment, this may simply include prompting the user/consumer for a particular type of image (e.g., picture of the user's face). Application logic may also identify the source of available UGC (i.e., social media sites, consumer/user's local device, etc.). For example, in the embodiment shown in FIG. 4, the first application logic is responsible for locating a UGC image for inclusion/embedding within the video provided with respect to node 402a.

In addition, the developer provides timing information regarding when (e.g., cut-in/cut-out times) the UGC image will be displayed within the context of the content delivered by the parent node. In this example, the image provided by the user will be displayed embedded within the video associated with node 402a. As such, the timing information indicates that the image will appear at time 1:15 and will end at time 1:28. In addition, application logic identifies where in the video content the UGC image will be embedded. During compilation of the content for delivery to the consumer, this information is used by content compiler 218 (shown in FIG. 2) to determine how to interleave content. In this particular example, information provided by node 402a and 404b tells content compiler 218 how the UGC image should be composited within the static video. In other embodiments, however, various other types of content, such as video, audio, text messages, etc. may be embedded as a sub-node within a parent node.

Finally, node 402a includes information identifying the next node to be traversed for purposes of determining UGC required for compilation, as well as for actual compiling of content for delivery to a consumer. In the embodiment shown in FIG. 4, the next node to be traversed is indicated by an arrow pointing to the next node, but in other embodiments may include a field that allows the developer to enter information identifying the next node to be traversed.

In the embodiment shown in FIG. 4, the developer creates node 402b, which the developer identifies as content type video, and identifies as the source of the video a second application logic developed to provide a user-generated video for inclusion in content provided to the consumer for consumption. Various types of application logic may be utilized to provide the desired UGC video for inclusion in the immersive content delivered to the consumer. For example, application logic may simply requests a particular video shot from the consumer for inclusion in the immersive content. Alternatively, second application logic may search the consumer's device or third party databases for video meeting a defined criteria, either based on analysis of the video or based on tags or descriptions associated with the video files. Alternatively, depending on whether the consumer's device has a camera, the second application logic may request use of the consumer's camera for a period of time to record the desired UGC video content. In addition, node 402b identifies the next node to be traversed as node 402c.

The developer next creates node 402c, which in this embodiment is a dynamic interaction with the consumer that results—based on input received from the consumer—on alternate paths being taken. The developer identifies the content type as a “Consumer Interaction”. Depending on the type of interaction required, different types of sources may be utilized. For example, for a consumer at a mobile device or computer, the consumer interaction may be via a web interface. In this case, the content source may be the address or URL associated with the web interface to be displayed to the consumer. In other embodiments, the content source may be application logic designed by the developer that provides the desired interaction with the consumer. In addition, it is not required necessarily that the consumer be aware of the interaction or choice. For example, in one embodiment the interaction and decision regarding the path to take is based on analysis of UGC associated with the consumer. Analysis may be based on attributes of the consumer, as assessed by analysis of UGC (e.g., blog posts, social media updates, image analysis of UGC images, etc.). The term “attribute” refers broadly to many factors associated with a consumer. For example, it could include mood the consumer (e.g., happy, sad), age of the consumer, social media habits (e.g., lots of post, lots of friends), relationship status, as well as changes in each of these attributes (i.e., relationship status changing from single to married). If required, the developer may provide timing information regarding provision and duration of the content provided. However, in many consumer interactions, content remains paused until the consumer interacts and therefore makes a choice, which is an option that may be provided by the developer. In contrast with previous nodes, in which progress was linear from one node to the next, node 402c provides links to node 402d and 402e, which are both conditioned on the interaction received from the consumer.

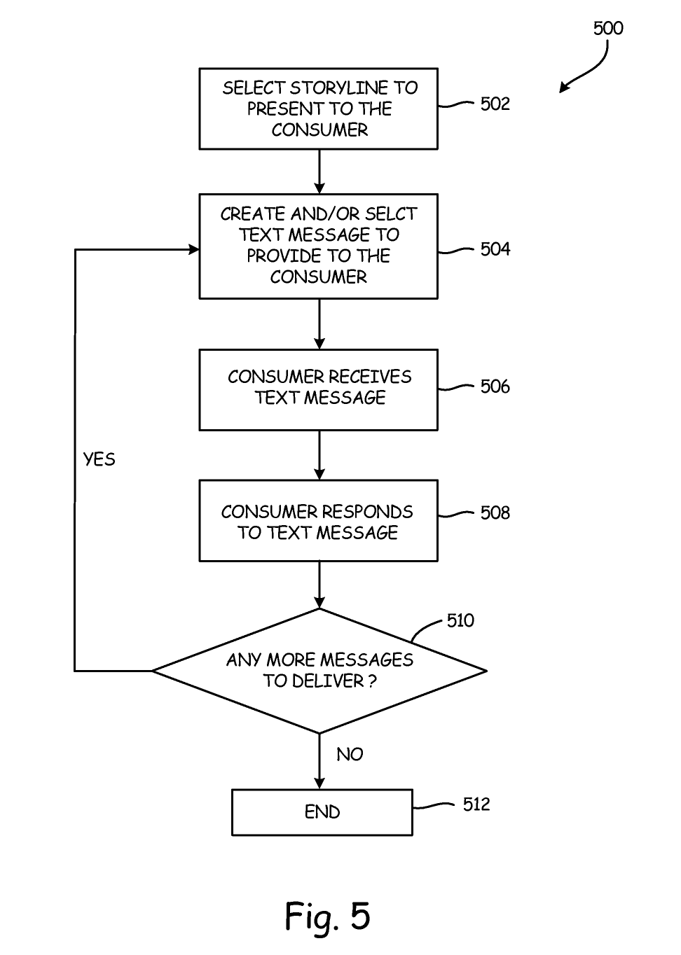

The developer then creates nodes 402d and 402e. In the embodiment shown in FIG. 4, node 402d provides computer-initiated telephone interaction with the consumer while node 402e provides text message interaction with the consumer. To create each node, the developer identifies the content type as “Telephone Call” and “Text Message”, respectively. With respect to node 402e, in some embodiments, the content source field may identify a text message or text message file to be sent to the consumer. That is, one or more text messages are sent in a defined order, without regard for consumer response to the received text messages. In another embodiment, the content source identified is another application logic program, execution of which is described in more detail with respect to FIG. 5, which interacts with the consumer via text message and responds with additional text messages based on responses received and analyzed from the consumer. This type of application logic may include artificial intelligence (AI) elements that allow the application logic to provide dynamic responses based on various consumer input. Immersive content (e.g., text messages) provided by the application logic program may draw from both consumer responses and previously collected UGC, and may include both traditional text messages (e.g., pre-recorded or static text messages) as well as those making use of UGC (e.g., including a UGC image, audio file, etc.) Typically, these type of interactions do not require a start time or an end time, and these fields will either not be presented when selecting the content type as “Text Message” or will be entered with a value of “None” or “Not Applicable”.

In addition, in the embodiment shown in FIG. 4, node 402e further includes one or more sub-nodes 404c and 404d that identify additional content to be embedded within the content delivered by parent node 402e. For example, a developer creates sub-node 404d (shown in more detail) to embed a user-generated image in the text message stream provided by parent node 402e. Thus, the developer identifies the content type as an image, and the source as the application logic responsible for selecting/retrieving the desired image. In this way, the text message exchange with the consumer defined by parent node 402e may additionally provide to the consumer a user-generated image as part of the text message exchange. Additional, other type of content may similarly be included if able to be embedded or included in a text message system.

With respect to node 402d, the content source field may similarly identify an audio file or previously recorded voice message to provide to the consumer via a telephone call or plurality of telephone calls. However, in another embodiment, the content source identified is another application logic program, similar to that discussed with respect to node 402e, which interacts with the consumer via a telephone call. Once again, this type of application logic may include AI elements that allows the application logic to provide dynamic responses based on various consumer input. Immersive content (e.g., telephone call) provided by the application logic program may draw from both static archives (e.g., pre-recorded audio files) as well as previously collected UGC. Typically, these type of interactions do not require a start time or an end time, and these fields will either not be presented when selecting the content type as “Text Message” or will be entered with a value of “None” or “Not Applicable”. Although no sub-nodes are illustrated with respect to node 402d , in some embodiments one or more sub-nodes may additionally be included within node 402d in order to embed content within content delivered by node 402d. In this example, the flow list ends at nodes 402d and 402e, depending on which path is selected, but could continue in the same manner laid out with respect to other nodes.

FIG. 5 is a flowchart illustrating method 500 implemented by application logic utilized to deliver immersive content in the form of text messages to a consumer according to an embodiment of the present invention. The method illustrated in FIG. 5 reflects actions taken by application logic following execution of node 402e, described with respect to FIG. 4, in which the content type of the node is identified as “Text Message” and the source file indicated is the application logic described herein.

At step 502, a storyline is selected by the application logic for provision to the consumer. In some embodiments, only a single storyline is available for delivery to the consumer, while in other embodiments a plurality of storylines (each a different piece of programming logic) may be available for provision to the consumer. Selection of one of the plurality of available storylines may be randomly selected, based on UGC received from the consumer or a third-party source, or based on interaction with the consumer.

At step 504, having selected the storyline, the application logic associated with that storyline creates and/or selects the first text message to provide to the consumer. The text message may be a static, pre-recorded text message (e.g., “hello”), or may include UGC or information obtained via analysis of UGC. For example, based on UGC analysis, the application logic may have the first name of the consumer receiving the text, in which case the text message provided may be “hello (name of consumer)”. In other embodiments, the text message may include additional UGC, such as an UGC image.

At step 506, the consumer receives the text message generated by the application logic. At step 508, the consumer optionally responds to the received text message, and at step 510 the application logic determines whether there are any more messages to deliver to the consumer. If no further messages will be delivered by application logic, then at step 512, then no more content is required to be delivered by this node, and progress continues to the next node for execution. If additional messages are required to be delivered, then the method continues at step 504 to determine the next text message to provide to the user. In one embodiment, the response provided by the consumer at step 508 may be utilized by the application logic to determine/select the next text message to provide to the consumer. In particular, this may include utilizing the consumer's response at step 508 in formulating the next text message to provide to the consumer. For this type of application, artificial intelligence programs incorporated into application logic may be utilized to dynamically respond to the consumer based on the feedback received.

Although method 500 specifically addresses an embodiment in which text messages are provided to the consumer, in other embodiments, the immersive content provided to the consumer may be in the form of a computer-automated telephone call, in which the application logic selects—rather than text messages—audio files to provide to the consumer in the form of a telephone conversation.

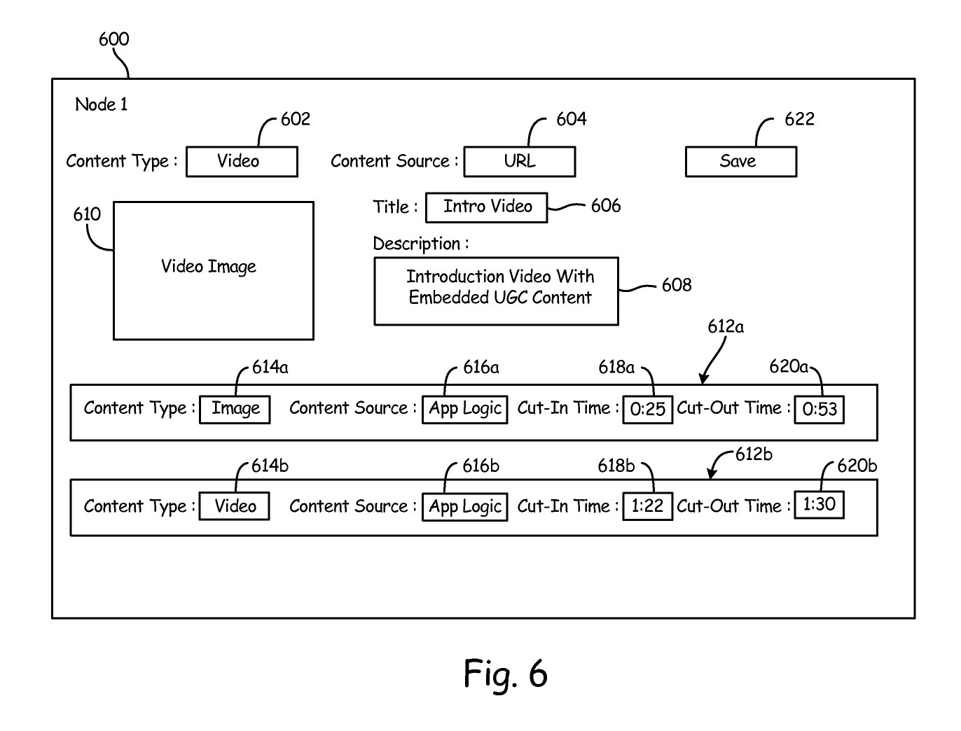

FIG. 6 is a development software screenshot illustrating creation of node 600 according to an embodiment of the present invention. In the embodiment shown in FIG. 6, node 600 (identified as “Node 1”) includes content type field 602, content source field 604, title field 606, description field 608, video image display 610, and sub-nodes 612a and 612b. Sub-nodes 612a and 612b each include content type fields 614a, 614b, content source fields 616a, 616b, cut-in times 618a, 618b, and cut-out times 620a, 620b, respectively.

As described with respect to FIG. 4, a developer builds a node by selecting the content type, the content source, and timing information. In the screenshot shown in FIG. 6, content type field 602 allows the developer to select a type of content. In one embodiment, content type field 602 must be selected first, with the selection of content type field 602 dictating the remaining fields made available to the developer. In the embodiment shown in FIG. 6, having selected “video’ as the content type, the developer identifies the content source by providing the address (e.g., URL) where the video content is stored in content source field 604. In the embodiment shown in FIG. 6, having identified the content source via content source field 604, an image representing the video content is placed in video image display field 610. For example, this may include the first frame or last frame of the video content, and serves as a visual reminder to the developer of the selected video content. In addition, in the embodiment shown in FIG. 6, the GUI associated with node 600 allows the developer to identify the node with a title and description via title field 606 and description field 608. Once completed, the developer uses save button 622 to save the node and/or publish the node to the flow list for consumption by a consumer.

In the embodiment shown in FIG. 6, one or more sub-nodes are added in order to embed content within the content delivered by node 600. For example, sub-node 612a is created to embed a user-generated image within the video content provided by node 600. To create sub-node 612a, a developer identifies the content type using content type field 614a, which in this case is identified as an image, but could include any number of content types. The developer further identifies the source of the content via content source field 616a, which in this case is UGC that is provided by application logic. In addition, the developer identifies where the UGC will be embedded within the content delivered by the parent node, which in this case includes providing cut-in and cut-out times via fields 618a and 620a. The developer may embed any number of additional sub-nodes within node 600 to embed additional content within the content delivered by node 600.

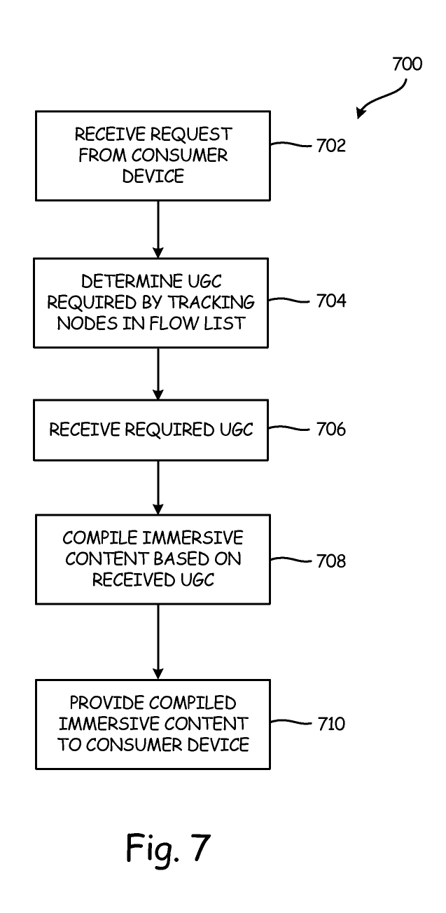

FIG. 7 is a flowchart illustrating method 700 of delivering immersive content to a consumer according to an exemplary embodiment of the present invention. At step 702, content management system 108 (shown in FIG. 1) receives a request from consumer device 102 (also shown in FIG. 1) requesting immersive content. Based on the immersive content requested by consumer device 102, at step 704, content management system 108 traverses the plurality of nodes associated with the flow list of the requested immersive content to determine the UGC required. This may include traversing the plurality of nodes associated with the entire flow list, or only a portion of the flow list. In another embodiment, the UGC required for the immersive content selected is stored in a file associated that can be provided to the consumer in response to the consumer's request for immersive content. The UGC required may be communicated to the consumer—in instances in which the consumer provides UGC directly—or may be collected automatically by content management system 108 from the consumer's device or from third party applications made available to content management system 108 by the consumer.

At step 706, the consumer provides UGC requested by content management system 108. In some embodiments, this may include the consumer providing UGC requested by content management system 108, while in other embodiments it may include allowing application logic (e.g., that associated with one or more nodes) provided by content management system 108 to automatically identify UGC from the consumer's device and/or third party servers to which the consumer has provided access. In some embodiments, this may further include utilizing application logic—again, associated with one or more nodes—to automatically analyze content supplied to identify attributes associated with the content that can be used to dictate what content is provided to the consumer and/or what path is taken within a particular flow list. For example, UGC may be analyzed to ascertain a mood/emotion associated with the consumer based on, for example, frequency of social media posts, content of posts, etc.

At step 708, content management system 108 compiles immersive content to be delivered to the consumer based on received UGC and analysis of received UGC where appropriate. Compiling of immersive content may include—as described with respect to FIG. 4—embedding UGC into traditional content. Compiling of immersive content may also include combining of content selected based on UGC received from the consumer. Because immersive content is unique to each consumer based on UGC provided by that consumer, immersive content—even immersive content relying mainly on traditional content—cannot be compiled until received UGC has been analyzed to determine what content to provide to the consumer.

In one embodiment, compiling of immersive content is completed on the server-side, such as by content compiler 218 shown in FIG. 2. However, in other embodiments, it may be beneficial to compile immersive content on the client-side via a client-side application provided by content management system 108. Whether compilation of immersive content is performed on the client-side or server-side depends on resources available on each side, and the amount of content to be shared between consumer device 102 and content management system 108.

Once compiled, at step 710 the compiled content (e.g., immersive content) is provided to consumer device 102 for consumption. In some embodiments, this process may be repeated several times. For example, for immersive content including several different branches or possible paths, compiled content may be provided only up to a decision point or interaction with the consumer, with additional immersive content compiled only after a branch or path has been selected.

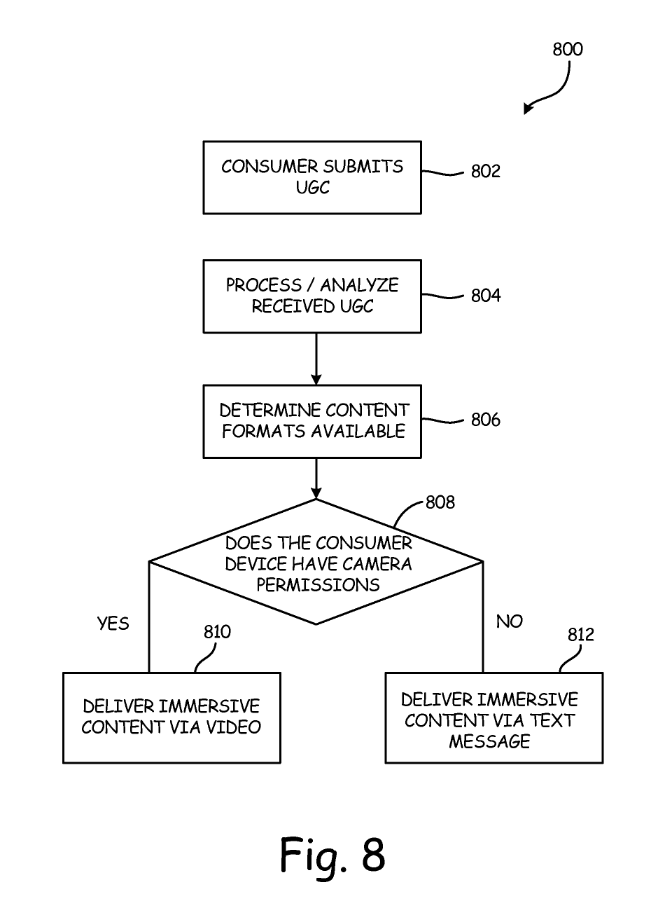

FIG. 8 is a flowchart illustrating a method 800 of delivering immersive content to a consumer based on the detected capabilities of the consumer's device according to an exemplary embodiment of the present invention. At step 802, consumer device 102 (shown in FIG. 1) submits UGC to content management system 108 (also shown in FIG. 1). Although not illustrated specifically, this would include steps described with respect to FIG. 7, in which consumer device 102 requests immersive content and content management system 108 collects UGC from the consumer either via request or via execution of application logic to retrieve UGC required. Having received UGC at step 802, at step 804 the content management server processes and/or analyzes received content. This may include selecting UGC for inclusion in the immersive content, and/or analyzing UGC for making determinations regarding path/branch to be taken with respect to immersive content.

At step 806 the content management system 108 determines—from a plurality of available formats for delivering immersive content—which are available to be received by the consumer. This may occur in the form of consumer requests for access to certain aspects of the consumer's device. For example, content management system 108 may request availability of a consumer's camera, microphone and/or speakers. Subsequent steps are specific to particular formats of immersive content. For example, at step 808, content management system determines whether consumer device 102 has camera permissions. If no, then at step 810, immersive content is delivered in the form of a text message provided to consumer device 102. If yes, then at step 812, immersive content is delivered to user device 102 in the form of a video conference call. The message, within the context of a larger story remains the same, only the communication medium (text message versus video call) changes, with content management server providing compiled, immersive content based on the capabilities of the consumer device and/or permissions received from the consumer device.

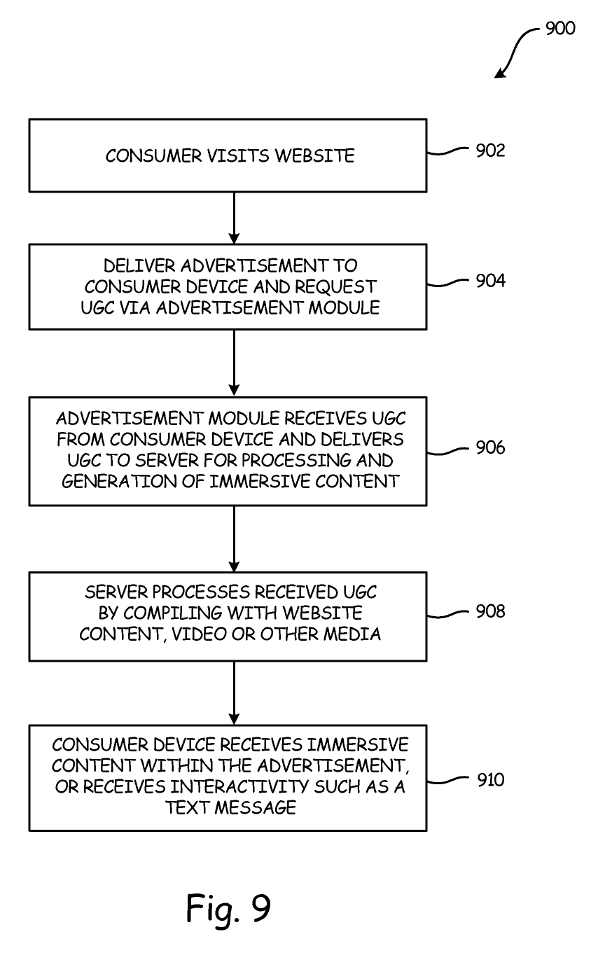

FIG. 9 is a flowchart illustrating delivery of immersive content as part of a digital advertisement according to an embodiment of the present invention. The premise is the same as that described with respect to FIG. 7, except immersive content is embedded as part of an advertisement delivered to the consumer.

In the embodiment shown in FIG. 9, at step 902 a consumer visits a website or webpage. At step 904 an advertisement is delivered to the consumer and part of the advertisement requests user-generated content (UGC) from the consumer/user. The advertisement may be in the form of a banner advertisement displayed to the user, or pop-up window.

In response to the request for UGC, the consumer interacts with the advertisement to provide UGC, which is in turn communicated to the server (e.g., server located within the content management system, described with respect to FIG. 1) for processing and creation of immersive content. As described in other embodiments, the UGC provided by the user may be in any number of forms, including text, pictures, video etc. provided by the user.

At step 908 the server compiles and processes the received UGC and creates immersive content to be delivered to the user. Creation of the immersive content may be completed as described with respect to FIGS. 2-4, in which content analyzer module 212 reviews the content provided by the user, flow list module 210 is traversed to determine the immersive content to be generated, and content compiler 218 generates the immersive content that is actually delivered to the user.

At step 910, immersive content is delivered to the user. In one embodiment, delivery of the immersive content may be as part of the initial banner advertisement displayed to the user. In another embodiment, the immersive content may be delivered via another communication medium (e.g., text sent to the user's device, interactive content, etc.).

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of creating immersive content comprised of both traditional content and user-generated content for consumption by a consumer, the method comprising:
creating a flow list that defines an order of immersive content;
attaching a content node to the flow list that defines user-generated content to be included in the flow list;
identifying for the attached node a type of user-generated content to be provided, a source of the user-generated content to be provided, and selection criteria for the user-generated content selected for inclusion in the content node; and
compiling immersive content for consumption by the consumer based on the plurality of content nodes and user-generated content made available for inclusion per one or more of the content nodes.

2. The method of claim 1, wherein the type of content identified for the node is selected from a group consisting of video files, image files, text files, and audio files.

3. The method of claim 1, wherein the source of content identified for the node is selected from a group consisting of a consumer's device, a consumer's social media information, a webpage that accepts input from the consumer, third-party participants, and consumer-identified content.

4. The method of claim 1, wherein selection criteria includes algorithms for selecting user-generated content without input from a consumer.

5. The method of claim 4, wherein selection criteria includes image analysis of available user-generated content.

6. The method of claim 5, wherein selection criteria includes tags, texts, or other descriptions describing available user-generated content.

7. The method of claim 1, further including attaching a content node to the flow list that defines interactive content to be retrieved from a consumer.

8. The method of claim 1, wherein user-generated content may be retrieved from more than one consumer.

9. The method of claim 1, wherein compiling immersive content for consumption by the consumer includes compositing user-generated content into traditional content to provide seamless immersive content to the consumer.

10. The method of claim 1, wherein the creation of the flow list, attachment of nodes to the flow list, and identification of type of user-generated content to be provided is done via a graphical user interface made available to a developer.

11. A method of delivering immersive content to a consumer, the method comprising:
receiving a consumer request for immersive content;
accessing user-generated content;
identifying within the user-generated content, selected user-generated content to be included within the requested immersive content;
compiling selected user-generated content with traditional content to create immersive content; and
delivering personalized, immersive content to the consumer.

12. The method of claim 11, wherein accessing user-generated content includes accessing content on a consumer's device and/or cloud-based content made available by the consumer.

13. The method of claim 12, wherein cloud-based content includes social media content made available by the consumer.

14. The method of claim 11, wherein identifying selected user-generated content includes analyzing user-generated content for attributes selected by a developer to fit within a story/plot of the immersive content.

15. The method of claim 14, wherein analyzing user-generated content includes analyzing tags, texts, and descriptions associated with user-based content.

16. The method of claim 14, wherein analyzing user-generated content includes performing image analysis.

17. An immersive content delivery system for providing immersive content to a consumer, the immersive content delivery system comprising:
an interface made available to a consumer on a consumer device for providing access to user-generated content;
a user-content analyzer, executed by a data processor, for accessing user-generated content and selecting based on one or more attributes user-generated content for inclusion in immersive content provided to the consumer; and
a compiler, executed by the data processor, for compiling traditional content with user-generated content to provide personalized, immersive content for consumption by the consumer.

18. The immersive content delivery system of claim 17, wherein the user-content analyzer detects consumer attributes based on user-based content.

19. The immersive content delivery system of claim 18, wherein immersive content delivered to a consumer is selected based on detected attributes of the consumer.

20. The immersive content delivery system of claim 17, wherein the user-content analyzer analyzes tags, texts, and descriptions associated with user-based content to select user-generated content appropriate for inclusion in the immersive content.

21. The immersive content delivery system of claim 17, wherein the user-content analyzer utilizes image analysis to select user-generated content appropriate for inclusion in the immersive content.
